(19) United States
(12) Patent Application Publication
(10) Pub. No.: US 2012/0005047 A1
(43) Pub. Date: Jan. 5, 2012

(54) Image-based e-commerce method and system

(76) Inventor: David Hughes, Sheridan, IN (US)

(21) Appl. No.: 13/175,825

(22) Filed: Jul. 2, 2011

Related U.S. Application Data
(60) Provisional application No. 61/361,375, filed on Jul. 2, 2010.

(51) Int. Cl. G06Q 30/00

(52) U.S. Cl. 705/27.2

(57) ABSTRACT

The present disclosure relates to systems and methods for providing, retrieving, manipulating and using data and information, primarily image-based, in the context of an e-commerce setting. More specifically, the present disclosure relates to systems and methods for presenting content to and using content from first users that is contained in images, to create a flexible and adaptable manner for disposition of items contained in the images to second, or more, users of the systems or internet site which employs these methods.

### CROSS-REFERENCE TO RELATED APPLICATIONS

Provisional Patent—61/361,375 Filed—Jul. 2, 2010 Inventor—David Hughes

### STATEMENT REGARDING FEDERAL SPONSORED RESEARCH OR DEVELOPMENT

Not Applicable.

### REFERENCE TO SEQUENCE LISTING, ETC.

Not Applicable.

### BACKGROUND

The present invention relates to a method and system for providing, retrieving, manipulating and using data and information in the context of an adaptable internet portal and most notably images in the e-commerce arena. More specifically, the present disclosure relates to a method and system for presenting content in images or videos, which are uploaded by a first user, and then allowing the first user to tag specific item(s) of content in those images or videos. Once completed, this image or video allows a multitude of other users to interact with the image or video and to purchase or otherwise obtain the item(s) tagged and identified by the first user.

As use of the internet has increased so has the number of users making purchases on the internet. This has lead to an explosion of online retailers and resellers, seeking to meet this increased demand. Much of the success of an online commerce site depends on how the users interact with the site. Central to this is that the experience with the systems and site must be easy, convenient and effective. While a number of the current sites, if not most, allow or provide images or videos of the items which are posted for sale on these websites, the ability to work with these images or videos, particularly when uploading and identifying the items for sale, is lacking In particular, person-to-person commerce sites lack critical functions that would add to the ease, convenience and effectiveness of these sites and specifically when dealing with a single image or video which may have multiple items which are to be sold or otherwise disposed.

### SUMMARY OF THE INVENTION

The present invention is a method and system to allow users to upload an image or video which contains multiple items for sale or other disposition. This invention allows a user to quickly and easily identify or tag these individual items with general and specific information about the item as well the terms of disposition. Likewise, this invention would then allow a second user to scan or search these collected images and videos in order to further interact with individual images or videos to determine what item or items are of interest and to provide a quick and convenient means in which to allow the second user to obtain the items or items of interest or to purchase all items found in the image or video.

### BRIEF DESCRIPTION OF THE DRAWINGS

FIG. 1 is a flow diagram of the logic of one embodiment of the present invention.

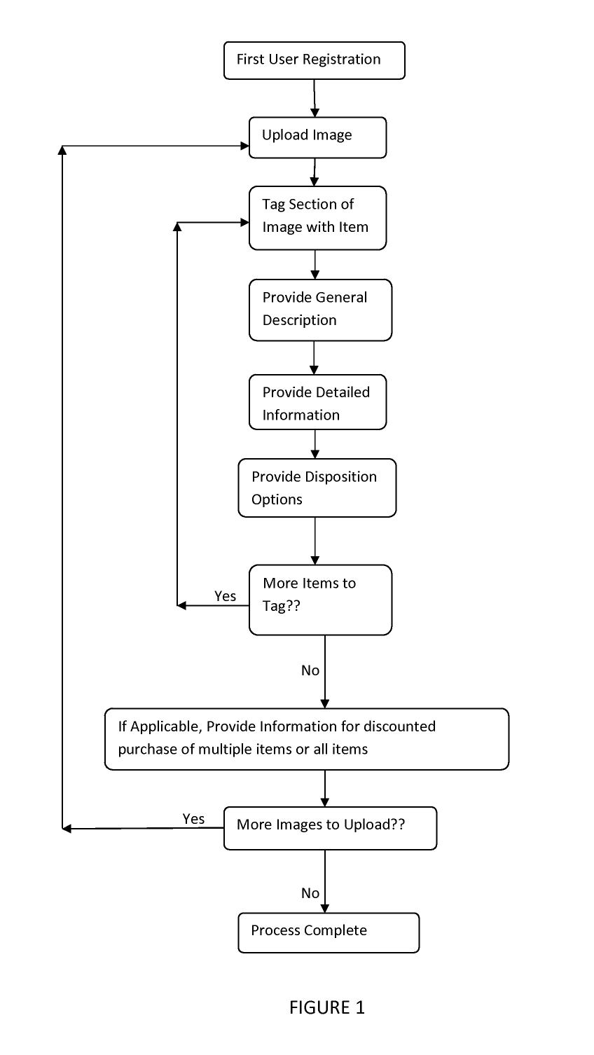

FIG. 2 is a flow diagram of the logic from a second user's perspective of one embodiment of the present invention.

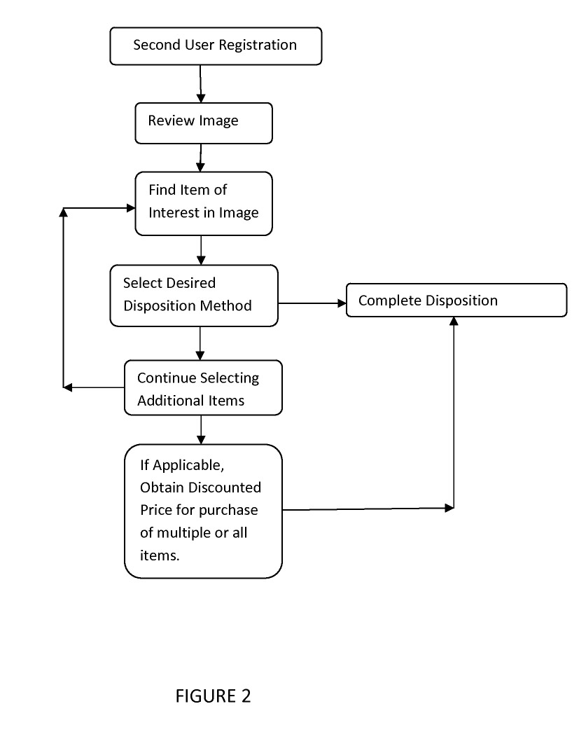

### DESCRIPTION

For the purpose of promoting an understanding of the principles of the present invention, reference will now be made to the embodiment illustrated in specific language contained herein. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

In the preferred embodiment of the present invention, consists of a method and system, hosted on an internet-based portal or site, in which a first user (“Seller”) can make certain items available for purchase or other disposition by other users of the site. In this embodiment, the Seller can upload an image containing one or more items for disposition. Once uploaded, the Seller prepares the item(s) for disposition, which could include sale, auction, trade or barter, by quickly and easily identifying the item or items in the image, by proximal location, and then, referencing this location, which thereby creates a pop-up box or other informational icon or dialog (“Pop-up”), that will appear when a second user (“Buyer”) hovers over the proximal location previously identified. The Seller then populates the Pop-up for each item or items with general and specific information about the item, as well as means of disposition. The means of disposition could include sale, auction, trade or barter. The Seller could then select or create the options associated with the manner of disposition selected, which could include directing the Buyer to a means in which to complete the transaction, which could include a standard on-line shopping cart, immediate purchase of the item or items, shipping or deliver options, or the ability to continue shopping for other items.

Compensation for the owner of the systems or site is provided through either some form of payment from the Seller, proceeds of advertising or sponsorships associated with the site, some form of payment from the Buyer, or some combination thereof.

The method and system of the above embodiment removes the previous limitations found in current sites by allowing first users to quickly and easily provide second users, which includes potential purchasers, with a vast amount of information about the item, or items, while giving the potential buyer the benefit of seeing an actual image of the item or items. The benefit is more fully realized when each image contains multiple items which are to be disposed. This eliminates the need for a first user to obtain images of each individual items and would allow a single image to provide for the disposition of all the contents of a room, garage or display table. Likewise, the benefits to the purchasers also include the ability to quickly and easily find items of interest, access a vast amount of information about the item, and move to a purchase decision very quickly and easily.

Another form of the present invention is focused on the sale of items which are the same or similar and are multiple in number or even sold in gross (“Commodities”). Unlike the first disclosed form of this invention, which is focused more on unique or one-of-a-kind items, this form is more for everyday items, which are all the same, but sold in great quantities, such as bread, laundry detergent or apparel. In this variation, the image would not necessarily be of the specific item to be purchased but rather merely an exemplar of the item.

In this embodiment, the Seller or retailer uploads an image containing an exemplar of the item or items that are to be offered for sale. The Seller then identifies the item or items in the image, by proximal location, and then, referencing this location, creates a pop-up box or other informational icon or dialog (“Pop-up”), that will appear when a second user (“Buyer”) hovers over the proximal location previously identified. The Seller could also then select or create the purchasing options that will be shown in the Pop-up, which could include directing the Buyer either to a standard on-line shopping cart, immediate purchasing of the item or items, shipping or deliver options, or the ability to continue shopping for other items.

Another form of the present invention involves the sale of both unique item(s) and Commodities. In this embodiment, instead of an image, a virtual photograph or drawing is created which contains a representation of the item or items to be offered for disposition. In this version, the Seller identifies the item or items in the virtual photograph or drawing, by proximal location, and then, referencing this location, creates a pop-up box or other informational icon or dialog (“Pop-up”), that will appear when a second user (“Buyer”) hovers over the proximal location previously identified. As in the other versions, the Seller could also then select or create the purchasing options that will be shown in the Pop-up, which could include directing the Buyer either to a standard on-line shopping cart, immediate purchasing of the item or items, shipping or deliver options, or the ability to continue shopping for other items.

Another form of the present invention involves method and system associated with an internet site which is not necessarily focused on the sale or other disposition of items, but rather information about certain items. In this embodiment, the first user uploads an image or video containing one or more items which the first user desires to provide information about said items to other users. Once uploaded, the first user identifies the proximal location of the item or items, and then, referencing this location, creates a pop-up box or other informational icon or dialog (“Pop-up”), that will appear when a second user hovers over the proximal location previously identified. The first user can populate the Pop-up for each item with as much, or as little, information, as the Seller wishes to provide, which could also include the ability to have a close-up examination of the item. In the event that this version was used by a retailer which also had a commerce element associated with the item, the first user could also then select or create the disposition options that will be shown in the Pop-up, which could include directing the second user either to a standard on-line shopping cart, immediate purchasing of the item or items, shipping or deliver options, or the ability to continue shopping for other items. This could be particularly useful for museums and other locations which sell copies or photographs of certain famous or unique items that are on display at the museum or other location.

Another variation of this invention provides a way to bring added depth to the user experience which could include providing items for sale or other disposition or in just providing knowledge and information. In this version, a first user uploads either a live video containing the item or items of interest or a 3-dimensional virtual rendering or image of the room or location, containing the item or items of interest. Once uploaded, the first user quickly and easily identifies the item or items, by proximal location, and then, referencing this location, creates a pop-up box or other informational icon or dialog (“Pop-up”), that will appear when a second user hovers over the proximal location previously identified. However, unlike the prior versions, this embodiment will provide for an immersive experience where the second user can actually move about the room or location containing the item or items and can interact it with just as if they were strolling in a store down the street. As in other versions, the first user then populates the Pop-up for each item or items with as much, or as little, information, as they wish to provide. As applicable, the first user could also then select or create the purchasing options that will be shown in the Pop-up, which could include directing the second user either to a standard on-line shopping cart, immediate purchasing of the item or items, shipping or deliver options, or the ability to continue shopping for other items.

All of the above referenced embodiments could also include icons, Pop-ups or other information specific to the second user or Buyer, providing such information as items examined or purchased, locations visited, or other information specific to that user's individual interactions with the systems or site.

It should also be noted that in all applicable variations, in addition to the direct purchase of an item or items, the systems or site could also be used as a way to allow second users or Buyers to bid on items of interest or exchange or barter the items. In this version, in addition to the other controls, the first user or Seller could also configure the individual elements of the related disposition such as length of time, reserve, or other requirements for the purchase.

While the invention has been illustrated and described in detail with the foregoing description, the same is to be considered as illustrative and not restrictive in character, it being understood that only the preferred embodiment has been described and that all changes and modifications that come within the spirit of the invention are desired to be protected.

What is claimed is:

1) A method of image-based e-commerce comprising:
a) a means for a first user to upload images or videos provided by the first user;
c) a means for a first user to tag a section, by proximal location, of the uploaded image or video in which the section contains a tagged item to be disposed;
d) a means for a first user to provide information about the tagged item;
e) a means for a first user to provide options associated with disposition of the tagged item;
f) a means for a first user to tag additional sections of the uploaded image or video to identify additional tagged items;
g) a means for a first user to provide for discounts or other special offers for the disposition of selected multiple tagged items;
h) a means for a first user to upload additional images and videos and to restart the tagging process for each additional image or video;
i) a means for a second user to access via search or other means, the images, videos and tagged items uploaded by the first user;
j) a means for a second user to select certain tagged items for disposition;
k) a means for a second user to complete disposition of tagged items when selected by a second user.

2) The method of claim 1 whereby the uploading means is contained on a web-site located on the internet or world wide web.

3) The method of claim 1 further comprising a means to register the first user and second user in order to facilitate the disposition of items by ensuring the veracity of the users, as well safeguarding the transaction including the financial aspects of the disposition.

4) The method of claim 1 whereby the means to tag a section of image or video is via a pop-up that is reactive to mouse movements over a certain part of the image or video.

5) The method of claim 1 whereby the means of disposition includes sale, auction, trade or barter.

6) The method of claim 1 whereby the image is either a 2-dimensional or 3-dimensional photograph.

7) The method of claim 1 whereby the image is a drawing.

8) A method of image-based information presentation comprising:
a) a means for a first user to upload images or videos provided by the first user;
b) a means for a first user to tag a section, by proximal location, of the uploaded image or video in which the section contains a tagged item in which the first user desires to provide information about said item;
c) a means for a first user to provide information about the tagged item;
d) a means for a first user to tag additional sections of the uploaded image or video to identify additional tagged items;
e) a means for a first user to upload additional images and videos and to begin the tagging process noted above for each additional image or video;
f) a means for a second user to access or search the images, videos and tagged items, to obtain the information and knowledge inserted by the first user.

9) The method of claim 8 whereby the uploading means is contained on a web-site located on the internet or world wide web.

10) The method of claim 8 whereby the means to tag a section of image or video is via a pop-up that is reactive to mouse movements over a certain part of the image or video.

11) The method of claim 8 whereby the image is either a 2-dimensional or 3-dimensional photograph.

12) The method of claim 8 whereby the image is a drawing.

13) A system of e-commerce comprising:
a) a means for a first user to register within a database to authorize further actions, such as uploading images or receiving funds;
b) a means for a registered first user to upload images or videos provided by the first user to an images database;
c) a means for the first user to identify or tag a section of the uploaded image or video in which the section contains a tagged item to be disposed;
d) a means to provide general information about the tagged item for second users to search for and find the item;
e) a means to provide detailed information about the tagged item for second users to search for and find the item but to also facilitate a disposition decision by the second user;
f) a means for the first user to provide options associated with disposition of the tagged item;
g) a means for a first user to tag additional sections of the uploaded image or video;
h) a means for a first user to provide for discounts or other special offers to second users, associated with disposition of multiple tagged items;
i) a means for a first user to upload additional images and begin the tagging process for each additional image or video;
j) a means for a second user to register within a database to authorize further action such as payment of funds or other disposition of selected tagged items either by sale, auction, barter or trade.
k) a means for a second user to search a database of images, videos and tagged items to select items for possible disposition;
l) a means for a second user to complete disposition of selected tagged items either by sale, auction, barter or trade.

14) The system of claim 13 whereby the means to tag a section of image or video is via a pop-up that is reactive to mouse movements over a certain part of the image or video.

15) The system of claim 13 whereby the means of disposition includes sale, auction, trade or barter.

16) The system of claim 13 whereby the image is either a 2-dimensional or 3-dimensional photograph.

17) The system of claim 13 whereby the image is a drawing.
